(19) United States
(12) Patent Application Publication
(10) Pub. No.: US 2012/0233382 A1
(43) Pub. Date: Sep. 13, 2012

(54) DATA STORAGE APPARATUS AND METHOD FOR TABLE MANAGEMENT

(75) Inventors: Taichiro Yamanaka, Hino-shi (JP); Yoko Masuo, Iruma-shi (JP); Hironobu Miyamoto, Yokohama-shi (JP)

(73) Assignee: KABUSHIKI KAISHA TOSHIBA, Tokyo (JP)

(21) Appl. No.: 13/304,188

(22) Filed: Nov. 23, 2011

(30) Foreign Application Priority Data
Mar. 11, 2011 (JP) 2011-054380

(51) Int. Cl. G06F 12/00

(52) U.S. Cl. 711/103; 711/E12.008

(57) ABSTRACT

According to one embodiment, a data storage apparatus includes a first memory configured to store a first management table, a second memory configured to store a second management table, a counter table memory, and a controller. The first management table has address data representing a storage position of data stored in a flash memory. The second memory has address data representing valid data included in the data stored in the flash memory. The counter table memory stores a counter table showing the count value of valid data in units of addresses. The controller is configured to refer to the first management table, to compare the number of data valid in units of addresses acquired by referring to the first management table, and to perform a matching check process for determining matching between the first and second management tables from a result of the comparison.

### CROSS-REFERENCE TO RELATED APPLICATIONS

This application is based upon and claims the benefit of priority from prior Japanese Patent Application No. 2011-054380, filed Mar. 11, 2011, the entire contents of which are incorporated herein by reference.

### FIELD

Embodiments described herein relate generally to a data storage apparatus using nonvolatile memories, and to a method for table management.

### BACKGROUND

In recent years, solid-state drives (SSDs) have been developed as data storage apparatuses, each using NAND flash memories (hereinafter referred to as “flash memories” in some cases) that are rewritable nonvolatile memories.

An SSD controller is known, which uses various data management tables in order to control the reading and writing of data from and to flash memories. The data management tables include a table showing the relation between, for example, physical blocks and logical blocks, and a table showing the latest of the data recorded.

The SSD is known to have hard errors resulting from, for example, the cosmic rays. The hard errors my induce bit errors in the data management table held in the internal memory of the SSD controller. In the SSD controller, discrepancy may consequently develop between the tables included in the data management table.

In the conventional SSD, the hard errors may cause discrepancy between the data management tables that are held in the internal memory of the SSD controller. Therefore, the SSD needs not only to perform ordinary read/write process, but also to determine check for the discrepancy between the data management tables. The process of checking for the discrepancy must be performed while the read/write process is not performed, and should therefore be performed at high speed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram explaining the configuration of the SSD according to an embodiment;

FIG. 2 is a diagram showing an exemplary format of the valid cluster bitmap table according to the embodiment;

FIG. 3 is a diagram showing an exemplary format of the valid-cluster number counter table according to the embodiment;

FIG. 4 is a diagram showing an exemplary VPN format according to the embodiment;

FIG. 5 is a diagram showing an exemplary format of the forward lookup table according to the embodiment;

FIG. 6 is a diagram an exemplary magic number of the forward lookup table entries according to the embodiment;

FIG. 7 is a flowchart explaining the table matching process according to the embodiment; and

FIG. 8 is a block diagram explaining the configuration of the SSD according to another embodiment.

### DETAILED DESCRIPTION

Various embodiments will be described hereinafter with reference to the accompanying drawings.

In general, according to one embodiment, a data storage apparatus includes a first memory configured to store a first management table, a second memory configured to store a second management table, a counter table memory, and a controller. The first management table has address data representing a storage position of data stored in a flash memory. The second memory has address data representing valid data included in the data stored in the flash memory. The counter table memory stores a counter table showing the count value of valid data in units of addresses. The controller is configured to refer to the first management table, to compare the number of data valid in units of addresses acquired by referring to the first management table, and to perform a matching check process for determining matching between the first and second management tables from a result of the comparison.

[Configuration of the Data Storage Apparatus]

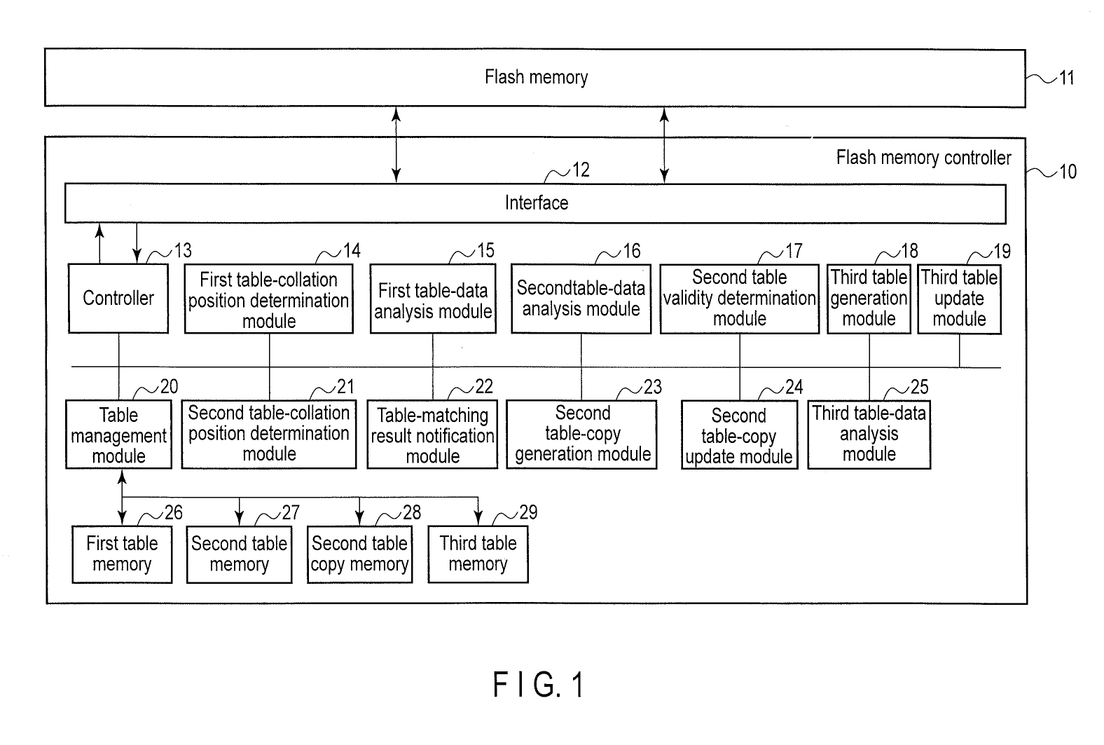

FIG. 1 is a block diagram explaining the configuration of the solid state drive (SSD) according to this embodiment. As shown in FIG. 1, the SSD comprises mainly of a flash memory controller (hereinafter referred to as an “SSD controller,” in some cases) 10, and a NAND flash memory (hereinafter referred to as a “flash memory,” in some cases) 11. The flash memory 11 are data storage media configured to store user data in the main.

The SSD controller 10 has an interface 12, a controller 13, a first table-collation position determination module 14, a first table-data analysis module 15, a second table-data analysis module 16, a second table validity determination module 17, a third table generation module 18, and a third table update module 19.

The SSD controller 10 further has a table management module 20, a second table-collation position determination module 21, a table-matching result notification module 22, a second table-copy generation module 23, a second table-copy update module 24, and a third table-data analysis module 25. Moreover, the SSD controller 10 has a first table memory 26, a second table memory 27, a second table copy memory 28, and a third table memory 29.

The interface 12 is connected to the flash memory 11 by channels (not shown) and is configured to input and output commands and data, all necessary in the read/write process. The channels (Ch) are transmission paths through which data is input and output to and from the flash memory 11. For example, 16 channels are provided in this SSD. Data can be transmitted at the same time, through 16 channels at most. The controller 13 controls the individual modules 14 to 25 connected to one another by a bus.

The table management module 20 manages the inquiries about the various tables, respectively stored in the first table memory 26, second table memory 27, second table copy memory 28 and third table memory 29, and also manages the table accesses, such as data updating, to these memories 26, 27, 28 and 29. The first table memory 26, second table memory 27, second table copy memory 28 and third table memory 29 are memories (storage devices) such as DRAMs.

The first table memory 26 stores a forward lookup table, which will be described later. The second table memory 27 stores a valid cluster bitmap table (hereinafter also called a “valid cluster table,” in some cases), which will be described later. The second table copy memory 28 stores a copy of one entry of the valid luster table, as will be explained later. The third table memory 29 stores a valid-cluster number counter table (hereinafter also called a “counter table,” in some cases), which will be describe later.

The first table-collation position determination module 14 determines the position of that entry of the valid cluster table stored in the second table memory 27, which is associated with the above-mentioned forward lookup table, from one entry of the forward lookup table that is stored in the first table memory 26. The second table-collation position determination module 21 determines that entry position of the forward lookup table stored in the first table memory 26, which is associated with the bit position of the valid cluster table entry, from the positions of the copy bits of the one entry of the valid cluster table stored in the second table copy memory 28.

The first table-data analysis module 15 analyzes the forward lookup table stored in the first table memory 26. The table-matching result notification module 22 notifies the result of the matching of the forward lookup table and the valid cluster table. That is, the module 22 notifies a higher system (CPU not shown) of the logical offset address (LCA) that is valid not only in one of the forward lookup table and the valid cluster table, but also in the other of these tables. The CPU executes the firmware (FW) that controls the entire SSD.

The second table-data analysis module 16 analyzes the entry data in the valid cluster table stored in the second table memory 27. The second table-copy generation module 23 generates a copy of one entry of the valid cluster table stored in the second table memory 27. The copy of the entry is stored in the second table copy memory 28.

The second table validity determination module 17 determines whether the cluster found valid by referring to the forward lookup table stored in the first table memory 26 is valid or not in the valid cluster table stored in the second table memory 27. The second table-copy update module 24 updates the entry data generated from the copy of the valid cluster table stored in the second table copy memory 28.

The third table generation module 18 generates a new counter table. The counter table is stored in the third table memory 29. The third table-data analysis module 25 analyzes the entry data of the counter table stored in the third table memory 29. The third table update module 19 updates the entry data in the counter table stored in the third table memory 29.

(Definition of the Terminology)

The terms used hereinafter in connection with the SSD according to this embodiment will be defined as follows.

A physical page is a data unit that can be read and written at a time in and from the flash memory 11. A “logical page” is a data unit that can be read and written at a time in and from the SSD. A “logical page” is a data unit associated with one or more physical pages.

A logical block is the smallest data unit that can be erased independently in the flash memory 11. The logical block is composed of a plurality of physical pages, and is an erasure data unit set in the SSD. Each logical block is associated with one or more physical pages.

A sector is the smallest accessible data unit a host system (e.g., personal computer) can access. A “cluster” is a data unit that is individually managed in the SSD. One cluster is associated with, for example, eight sectors. An integral multiple of 2 or more of the cluster size corresponds to the logical page size.

Valid cluster is a cluster that holds the latest data is a valid cluster. An “invalid cluster” is a cluster that holds data other than the latest data. “Compaction” is a process of extracting any valid cluster from a logical block being managed and written in a new logical block.

Planes (hereinafter referred to as “PL,” in some cases) are zones in the same flash memory chip, which can be accessed at the same time. In this embodiment, the flash memory chip is divided into two planes. Nonetheless, the number of planes is not limited to two. The flash memory chip can be divided into more planes.

A block ID (hereinafter also called an “LBID,” in some cases) is a number assigned to a logical block, identifying the logical block.

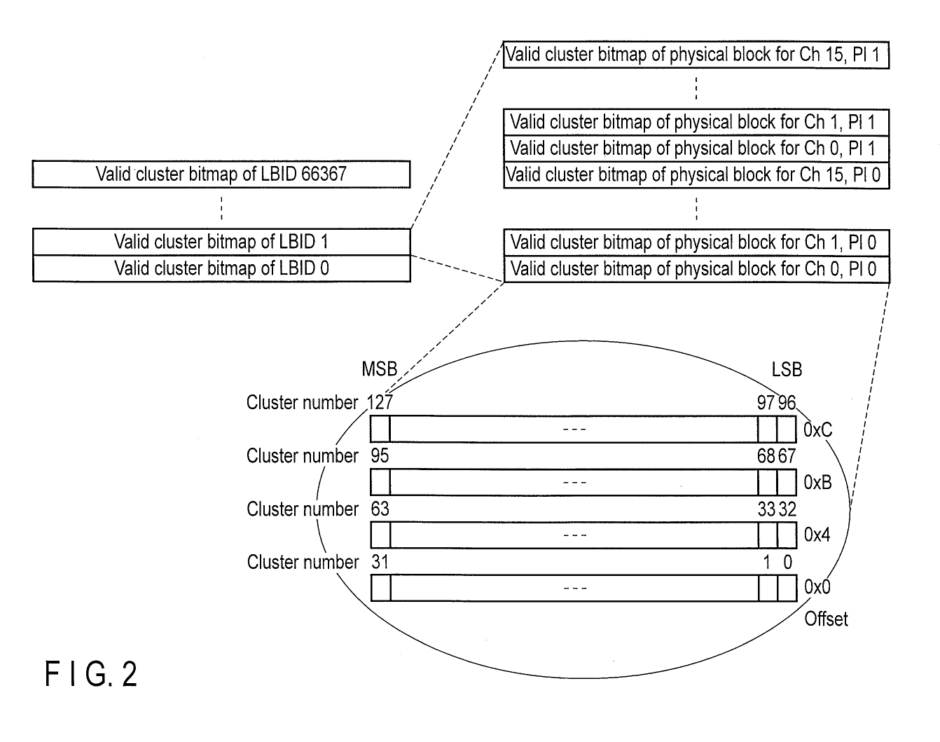

Valid cluster bitmap is data composed of bits, each bit indicating that the data recorded as logical block is valid or invalid. More precisely, the bit indicates that the data is valid if it is “1,” and invalid if it is “0.” A “valid cluster bitmap table” (or “valid cluster table”) is a table that manages the valid cluster bitmap. The valid cluster table has such a structure as shown in FIG. 2.

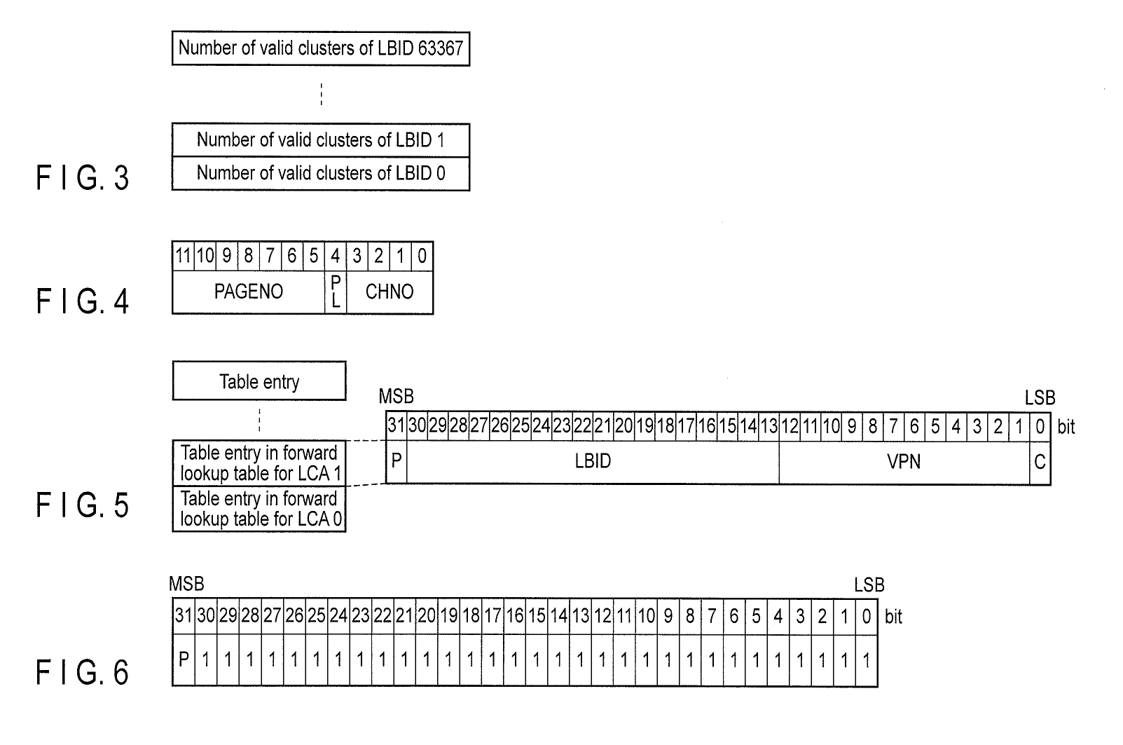

Valid cluster number counter is data representing the number of valid clusters (i.e., valid cluster number) existing in the data stored in a logical block. The valid cluster number counter is data used to select a compaction object at the time of compaction. A “valid-cluster number counter table” (or “counter table”) is a table in which the valid cluster number counter is used as logical block ID as a key. In this embodiment, the counter table has such a format as shown in FIG. 3. In the counter table, the cluster numbers are arranged, each using the logical block ID (LBID) as index.

LCA is a value obtained by shifting the logical block address (LBA) to the right by three bits. VPN is a virtual page. As shown in FIG. 4, VPN is composed of the number PAGEND of a physical page in the physical block, the number PL of a plane in the flash memory, and a channel number CHNO.

Logical cluster address is a cluster address on the flash memory. The logical cluster address is expressed by the logical block ID, the virtual page number (VPN) and the cluster offset (C) existing in the physical page. The forward lookup table is a table that manages the logical storage positions of clusters on the flash memory. The forward lookup table of this embodiment is, as shown in FIG. 5, an array of data entries LBID, VPN and C, each entry indexed with LCA. “P” in FIG. 5 is a parity bit.

FIG. 6 is a diagram showing an exemplary magic number of the forward lookup table. The magic number is defined by bits that are all “0,” except the parity bit (P) of the forward lookup table. This means that data has never been written in the sectors included in the associated LCA since the activation of the SSD.

(Process of Checking the Table Matching)

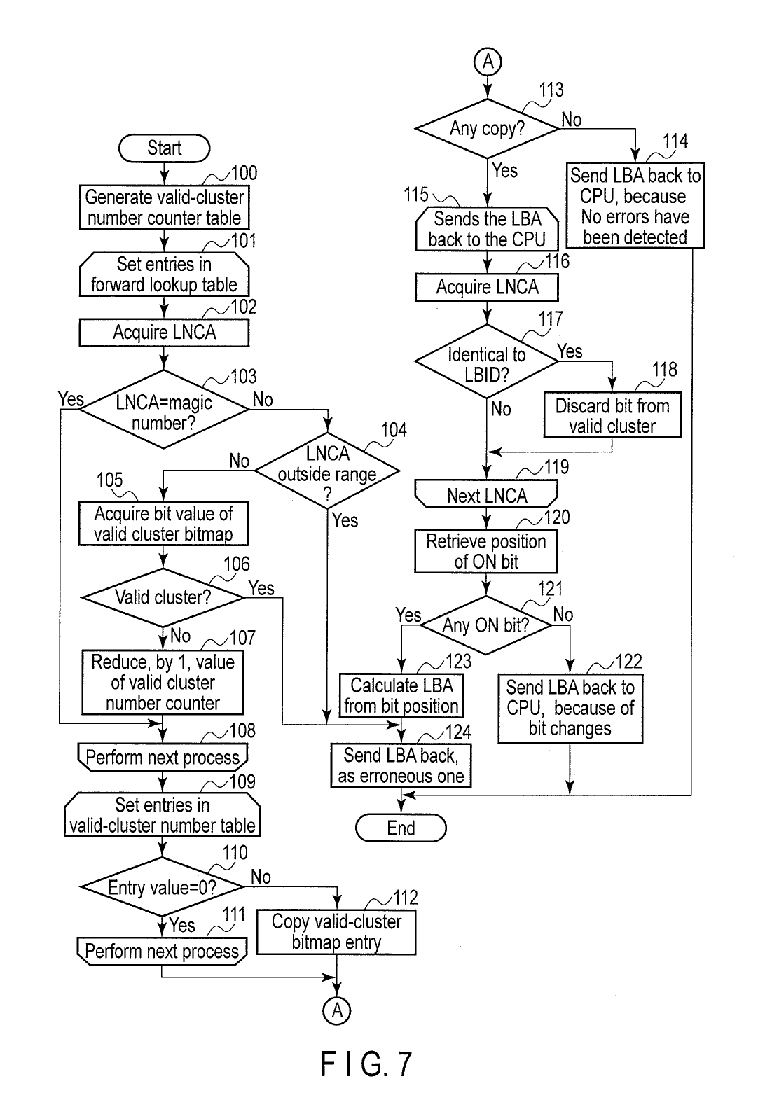

How the table matching is checked in this embodiment will be explained with reference to the flowchart of FIG. 7.

In the embodiment, the controller controls the individual modules 14 to 25, checking the matching between the forward lookup table and the valid cluster bitmap table (or valid cluster table).

As described above, the forward lookup table is a table stored in the first table memory 26. Herein, this table is also called the “first management table,” in some cases. The valid cluster table is a table stored in the second table memory 27, and is also called the “second management table,” herein in some cases.

In this embodiment, the first management table and the second management table must not be updated in parallel during the matching check process performed on these tables. In each matching check process, only one position of discrepancy can be detected. When the table-matching result notification module 22 detects any discrepancy, it informs the CPU of the position of discrepancy and the result of the result of the matching check process performed on the tables.

First, the third table generation module 18 counts valid “1s,” in units of clusters, for every logical block (LBID) from the valid cluster table stored in the second table memory 27, generating a valid-cluster number counter table (or counter table) (Block 100). The third table generation module 18 then stores the counter table, as third management table, in the third table memory 29.

The valid cluster table is a table representing a bitmap in which “1” shows a valid cluster and “0” shows an invalid cluster as seen from FIG. 2. As shown in FIG. 3, the counter table is a table consisting of data representing the number of valid clusters existing in each block logical block (LBID).

Next, the controller 23 uses the counter table (i.e., third management table) thus generated, performing the matching check process on all entries of the forward lookup table (i.e., first management table) (loop of Blocks 101 to 108). Note that Block 108 is the end of the process loop.

More specifically, the first table-collation position determination module 14 requests the table management module 20 to refer to the forward lookup table stored in the first table memory 26 in the order of LCAs, and acquires a logical cluster address (LNCA) (Block 102). As shown in FIG. 5, LNCA is composed of a logical block ID (LBID), a virtual page number (VPN), and the cluster offset (C) contained in a physical page.

The first table-data analysis module 15 check the validity of the LBID contained in the LNCA acquired (Block 103). If the NNCA is found to be a magic number (YES in Block 103), the first table-data analysis module 15 acquires the next LNCA to be processed. In the magic number, all bits are “1,” except the parity bit (P) of the forward lookup table. This means that data has never been written in the sectors included in the associated LCA.

If the NNCA is not a magic number and if LNCA falls outside a prescribed range (YES in Block 104), the table-matching result notification module 22 acquires the logical block address (LBA) calculated from the LCA. The module 22 sends the LBA, together with an error, back to the CPU, i.e., higher system (Block 124). Then, the process is terminated.

If the LNCA falls within the prescribed range (NO in Block 104), the second table-data analysis module 16 acquires, through the table management module 20, the bit value of the physical cluster contained in the valid cluster table (Block 105). The second table validity determination module 17 uses the bit value of the physical cluster, determining whether the physical cluster contained in the valid cluster table is invalid (Block 106).

If the physical cluster is invalid (YES in Block 106), the table-matching result notification module 22 acquires the logical block address (LBA) calculated from the LCA and sends this logical block address, together with the error, to the CPU, i.e., higher system (Block 124). Then, the process is terminated. If the physical cluster is valid (NO in Block 106), the third table update module 19 decrements by one the count value for the logical block (LBID) on the third management table (i.e., counter table) (Block 107).

After completely checking the all entries in the forward lookup table (after the loop of Blocks 101 to 108), the controller 13 goes to the next process. More precisely, the third table-data analysis module 25 checks the entries of the third management table (i.e., counter table), from the first entry to the last entry (Blocks 109 and 110). If the entry checked first has value of zero (YES in Block 110), the third table-data analysis module 25 starts checking the next entry (Block 111).

If the entry checked first does not has value of zero (NO in Block 110), the third table-data analysis module 25 transfers the LBID, i.e., the entry value, to the second table-copy generation module 23. The second table-copy generation module 23 causes the table management module 20 to refer to the associated valid cluster table. The second table-copy generation module 23 acquires the bitmap table acquired from the valid cluster table and stores the same in the second table copy memory 28 (Block 112). Thus, the copy of one entry in the valid cluster table stored in the second table memory 27 is stored in the second table copy memory 28.

If the second table copy memory 28 stores no data, or if the memory 28 does not store the copy of one entry of the valid cluster table, the table-matching result notification module 22 determines that no errors have been detected (YES in Block 113). In this case, the table-matching result notification module 22 sends the LBA back to the CPU, i.e., higher system, and terminates the process (Block 114).

If the second table copy memory 28 stores the copy of one entry of the valid cluster table (YES in Block 113), the first table-collation position determination module 14 requests the table management module 20 to refer to the forward lookup table stored in the first table memory 26 in the order of LCA (Block 115). The first table-collation position determination module 14 thereby acquires the logical cluster address (LNCA) (Block 116).

The first table-data analysis module 15 checks the LBID contained in the LNCA for the validity thereof (Block 117). In other words, the module 15 determines whether the LNCA is a magic number, or whether the LBID is identical to the LBID of the (sole) valid-cluster bitmap data stored in the second table copy memory 28. If the LNCA is a magic number (NO in Block 117), the first table-collation position determination module 14 acquires the next LNCA to be processed (Block 119). If the LNCA is not identical to the LBID of the valid-cluster bitmap data (NO in Block 117), the module 14 also acquires the next LNCA to be processed (Block 119).

On the other hand, if the LNCA is identical to the LBID of the valid-cluster bitmap data (YES in Block 117), the second table-data analysis module 16 calculates the position the bit takes in the bitmap data of the valid cluster stored in the second table copy memory 28. In this case, the second table-copy update module 24 discards this bit from the valid cluster (Block 118).

After all entries of the forward lookup table have been checked (that is, after the loop of Blocks 115 to 119 has been completed), the controller 13 goes to the next process. More precisely, the second table-data analysis module 16 retrieves the position of any bit having value “1” in the bitmap data of the valid cluster stored in the second table copy memory 28 (Block 120).

If the second table-data analysis module 16 retrieves no bits having value “1” (NO in Block 121), the table-matching result notification module 22 determines that bits have changed in the data during the data processing. In this case, the module 22 sends the LBA back to the CPU i.e., higher system, and terminates the process (Block 122).

At the time the logical block identified by the bitmap of the valid cluster is copied in the second table copy memory 28, the logical block is found to have a physical cluster that is invalid in the forward lookup table and valid in the valid cluster table. Hence, the valid cluster table must contain any bit having value “1” at the time the second table-data analysis module 16 retrieves bit positions. If the data has undergone bit changes, however, the valid cluster table may have no bits having value “1.” Thus, in Block 122 that is performed if NO in Block 212, the table-matching result notification module 22 informs the CPU that the process can no longer be performed because bits have changed in the data.

If the second table-data analysis module 16 retrieves any bit that has value “1” (YES in Block 121), it transfers the LCA of the entry identical to the LNCA calculated from the forward lookup table, to the table-matching result notification module 22. More specifically, the second table-collation position determination module 21 first calculates the LNCA associated with the position of the bit “1” (i.e., LSB if a plurality of bits have value “1”) from the valid cluster table, then retrieves the entry identical to the LNCA, and finally sends the LCA of the key associated with the entry, to the table-matching result notification module 22. The table-matching result notification module 22 acquires the logical block address (LBA) calculated from the LCA (Block 123 if YES in Block 121), and sends the logical block address back to the CPU, i.e., higher system, together with the errors (Block 124). The module 22 then terminates the process.

As described above, the matching check process according to this embodiment uses the valid-cluster bitmap table (counter table), i.e., third management table, to achieve matching between the forward lookup table (first management table) and the valid-cluster bitmap table (second management table).

The essence of the matching check process according to this embodiment lies in first counting the valid clusters of each physical block recorded in the counter table and the valid clusters read from the forward lookup table (i.e., physical cluster addresses registered), and then comparing the number of valid clusters with the number of the physical block with the number of valid clusters read from the forward lookup table. That is, it is determined whether the physical clusters of the valid cluster table, which correspond to the valid clusters in the forward lookup table, are valid or invalid. If these physical clusters are invalid, discrepancy exists between the counter table and the forward lookup table and the position of discrepancy can be specified. If these physical clusters are valid, the count value (i.e., number of valid clusters) of the counter table is decremented (the loop of Blocks 101 to 108). If the tables (i.e., forward lookup table and valid cluster table) have the same number of clusters, the matching check process is terminated (Blocks 111 and 114). If the tables have different numbers of clusters, the process (Blocks 115 to 124) of specifying the position of the discrepancy cluster will be performed.

In the matching check process, which is performed in two steps as described above, the step of specifying the position of the discrepancy cluster need not be performed if no discrepancy is detected between the two tables. This reduction of process steps increases the speed of the matching check process. As a result, the matching between the data management tables can be achieved at high speed.

Moreover, the storage capacity required for the matching check process can be minimized. In other words, the matching check process can be performed even if the SSD has but a relatively small storage capacity. Hence, the errors made in the data management tables, resulting from hard errors, can be easily analyzed in the SSD.

### Modified Embodiment

The matching check process of this embodiment has been described on the assumption that only one position of discrepancy can be detected. Nonetheless, a plurality of positions of discrepancy may be detected in the matching check process.

In a modified embodiment, not one bitmap is used for a physical block, i.e., entry data in the valid cluster table stored in the second table copy memory 28, but bitmaps are for respective physical blocks, i.e., entry data in all valid cluster tables, of which the entry checked first has value of zero (YES in Block 110 in FIG. 7). Hence, discrepancy can be detected for a plurality of physical blocks, by performing the matching check process only once.

### Other Embodiment

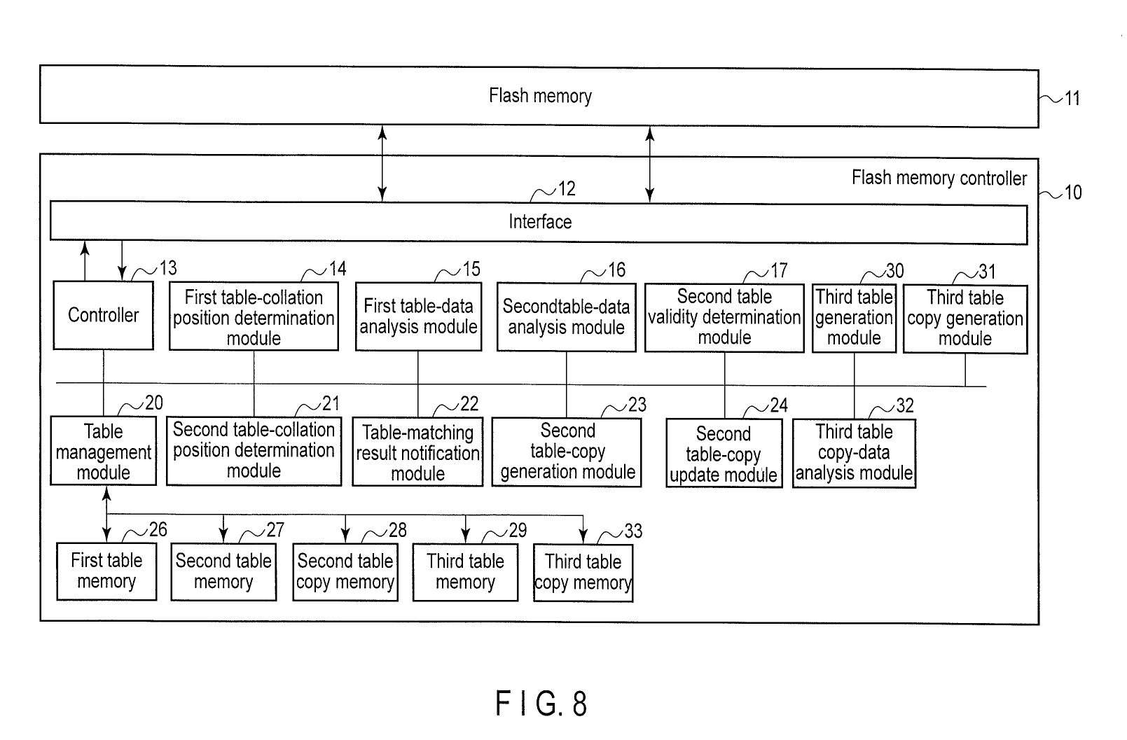

FIG. 8 is a block diagram explaining the configuration of the SSD according to another embodiment.

The embodiment described above is configured to generate a valid-cluster number counter table (third management table) (see Block 100). By contrast, this embodiment is configured to prepare the counter table and use this table to perform the matching check process. In order to maintain each entry value in the valid-cluster number counter table in the state appropriate for the SSD system, the table should be updated at the time the user data is written in the flash memory 11, at the time the user data is erased in the flash memory 11, or at the time the physical storage position of the user data is moved as compaction is performed. If the valid-cluster number counter table is updated at any one of the timings specified above, it can be utilized as data for selecting the smallest logical block (composed of the least valid clusters), as a compaction object, in the compaction process that is another process in the SSD. This is one of the advantages of this embodiment. Note that this embodiment is based on the assumption that the table is updated at the appropriate timing specified above.

To be more specific, the third table generation module 18, the third table update module 19 and the third table-data analysis module 25 are replaced by a third table copy generation module 30, a third table copy update module 31 and a third table copy-data analysis module 32, respectively, as seen from FIG. 8. Further, a third table copy memory 33 is added as table memory that the table management module 20 manages.

In this embodiment, the third table memory 29 stores the existing valid-cluster counter table (counter table). The third table copy memory 33 stores a copy of the entire counter table stored in the third table memory 29. The copy of the entire counter table is so stored, for the purpose of preventing the original counter table from being destroyed when the entry value in the counter table is updated during the matching check process performed in this embodiment. The third table copy generation module 30 copies the entire counter table stored in the third table memory 29. The copy of the counter table is stored in the third table copy memory 33.

The third table copy-data analysis module 32 analyzes the entry data in the counter table stored in the third table copy memory 33. The third table copy update module 31 updates the entry data in the counter table stored in the third table copy memory 33.

In this embodiment so configured, the third table copy generation module 30 copies the entire counter table stored in the third table memory 29 in the third table copy memory 33, so that the existing valid counter table may be utilized. The copied data may be referred to or be updated, performing the matching check process. In this case, the process of counting “1s” representing the validity of the entries in the counter table is replaced by the process of copying the entry values. This can simplify the entire process the SSD controller 10 performs.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a flash memory;
a first memory configured to store a first management table having address data representing a storage position of data stored in the flash memory;
a second memory configured to stored a second management table having address data representing valid data included in the data stored in the flash memory;
a counter table memory configured to store a counter table showing the count value of valid data in units of addresses; and
a controller configured to refer to the first management table, to compare the number of data valid in units of addresses acquired by referring to the first management table, and to perform a matching check process for confirming matching between the first and second management tables from a result of the comparison.

2. The data storage apparatus of claim 1, wherein the controller is configured to perform a first process and a second process in the matching check process; in the first process, the controller uses the counter table, comparing the number of valid data acquired by referring to the first management table, with the number of valid data acquired by referring to the second management table, and terminates the process in a normal state if the numbers compared is equal to each other; and in the second process, the controller specifies a position of non-matching if the numbers compared differ from each other.

3. The data storage apparatus of claim 1, wherein the counter table memory is configured to store the counter table prepared before the matching check process is performed.

4. The data storage apparatus of claim 1, further comprising a generator configured to generate the counter table from the second management table,
wherein the counter table memory stores the counter table generated by the generator.

5. The data storage apparatus of claim 1, wherein the first management table is a forward lookup table showing a position where data is stored in units of clusters; the second management table is a valid-cluster bitmap table showing whether data is valid or invalid in units of clusters; the counter table is a valid-cluster number counter table having a count value obtained by counting the valid clusters counted in units of addresses in the second management table; and the controller is configured to use the counter table, performing a process of determining whether the valid cluster number in the first management table is equal to the valid cluster number in the second management table.

6. The data storage apparatus of claim 5, wherein the controller is configured to perform a first process and a second process in the matching check process; in the first process, the controller compares the number of valid data, confirmed by referring to the first management table, with the number of valid data acquired from the second management table, and terminates the process in a normal state if the numbers compared are equal; and in the second process, the controller specifies a position of a cluster not matching between the first and second management tables if the numbers compared differ from each other.

7. The data storage apparatus of claim 6, wherein the controller is configured to perform the first process, first determining whether the cluster contained in the second management table and associated the cluster contained in the first management table is valid or invalid, then decrementing the count value of the counter table if the cluster is valid, and finally confirming that the valid clusters in the first and second management tables are identical, if the count value decremented is zero.

8. A method for table management for use in a data storage apparatus having a first management table having address data representing a storage position of data stored in a flash memory, and a second management table having address data representing valid data included in the data stored in the flash memory, the method comprising:
acquiring a number of valid data from a counter table, in units of addresses;
comparing the number of data valid in units of addresses acquired by referring to the first management table with a count value acquired in units of addresses from the counter table: and
performing a matching check process for confirming matching between the first and second management tables from a result of the comparison.

9. The method of claim 8, wherein the matching check process comprises:
using the counter table, thereby comparing the number of valid data acquired by referring to the first management table, with the number of valid data acquired by referring to the second management table;
terminating the process in a normal state if the numbers compared is equal to each other; and
specifying a position of non-matching if the numbers compared differ from each other.

10. The method of claim 8, wherein the first management table is a forward lookup table showing a position where data is stored in units of clusters; the second management table is a valid-cluster bitmap table showing whether data is valid or invalid in units of clusters; the counter table is a valid-cluster number counter table having a count value obtained by counting the valid clusters counted in units of addresses in the second management table; and in the matching check process, the counter table is used, determining whether the valid cluster number in the first management table is equal to the valid cluster number in the second management table.

11. The method of claim 10, wherein the matching check process comprises:
comparing the number of valid data, confirmed by referring to the first management table, with the number of valid data acquired from the second management table;
terminating the process in a normal state if the numbers compared are equal; and
specifying a position of a cluster not matching between the first and second management tables if the numbers compared differ from each other.

12. A data storage control apparatus comprising:
a first memory configured to store a first management table having address data representing a storage position of data stored in a flash memory;
a second memory configured to stored a second management table having address data representing valid data included in the data stored in the flash memory;
a counter table memory configured to store a counter table showing the count value of valid data in units of addresses; and
a controller configured to refer to the first management table, to compare the number of data valid in units of addresses acquired by referring to the first management table, and to perform a matching check process for confirming matching between the first and second management tables from a result of the comparison.
